(19) United States
(12) Patent Application Publication
(10) Pub. No.: US 2013/0297397 A1
(43) Pub. Date: Nov. 7, 2013

(54) SYSTEMS FOR AND METHODS OF AUGMENTING FINANCIAL TRANSACTIONS SERVICES

(71) Applicant: OXYGEN FINANCE LIMITED, Leeds (GB)

(72) Inventors: David Brown, Bromley (GB); Mark Taylor, Buckinghamshire (GB); Mike Murphy, Cheltenham (GB); Keith Cotterill, Menlo Park, CA (US)

(73) Assignee: Oxygen Finance Limited, Leeds (GB)

(21) Appl. No.: 13/874,707

(22) Filed: May 1, 2013

Related U.S. Application Data
(60) Provisional application No. 61/641,608, filed on May 2, 2012.

(51) Int. Cl. G06Q 30/02

(52) U.S. Cl. CPC G06Q 30/0234
USPC 705/14.34; 705/39

(57) ABSTRACT

Under an agreement between a buyer and a supplier, the buyer agrees to a minimum purchase and receives a flexible early-payment rebate on each individual transaction between the two. Because of the purchase and early-payment agreement, the transaction services can be bundled with other services such as foreign exchange and insurance. This “bundling” may be performed electronically based on business rules and preferences, and is described as the “augmentation” of financial services with electronic payment services within a network including buyer and supplier. Thus, on a per-transaction basis, each transaction can receive a rebate, be covered by insurance, and receive the benefit of favorable foreign-exchange rates. The buyer can configure a system such that specific services are applied to specific transactions. The buyer or supplier can also generate reports that detail the rebates, as well as the savings associated with each transaction by service.

### RELATED APPLICATION(S)

This application claims priority under 35 U.S.C. §119(e) of the co-pending U.S. provisional patent application Ser. No. 61/641,608, filed May 2, 2012, and titled “Methods and Apparatuses for Capturing and Reporting Supplier Rebates, Augmenting Outsourced Payments, and Establishing a Closed-Loop Business Payment Network,” which is hereby incorporated by reference in its entirety.

### FIELD OF THE INVENTION

This invention relates to commercial transactions. In particular, this invention relates to creating, provisioning, and implementing supplementary financial transactions alongside outsourced business payment services.

### BACKGROUND OF THE INVENTION

Business-to-business interactions between buyers and suppliers involve a number of communications and exchanges of information related to contracts, product information, orders, invoices, shipments and other transactions. However complex these interactions may be, there is always an exchange of financial value—a payment—that takes place at some point in a transaction cycle between the buyer and supplier. This payment stage is typically regarded as the conclusion of many internal and external processes performed by buying organizations—such as budget, order and invoice approval—and represents a standalone final step in the purchasing cycle. Prior art systems do not regard the payment stage as an opportunity to augment the simple payment event with additional financial, logistical, informational and other services. These systems offer blanket or umbrella services independent of such payments.

As one example, in an effort to get buyers to purchase more products and to pay for these products earlier, some suppliers offer incentive programs, such as rebate programs that reward buyers who purchase a minimum volume of a product. For example, an electronics component distributor (buyer) commits to purchase 100,000 components in a year, for a total value of $10 million. In return for attaining this volume, the buyer receives a 2.5% rebate as a periodic credit or payment.

At the end of an accounting period, however, this type of rebate program typically experiences problems arising from reconciling the account, problems involving time, cost, and delay. Many buyers are not inclined to take advantage of rebate programs because they do not receive the benefits until long after the purchases are made, after purchase orders have been processed and after invoices have been matched. Often, invoices are processed weeks after they are received, too late to take advantage of many rebate programs. As a further disincentive, such programs are general, not tailored to individual buyers' needs or resources, and therefore do not maximize returns for the individual buyer. For tax purposes, these rebates are difficult to classify and often require a buyer to reclassify or adjust its tax documents. Buyers see little value in incentive programs that are inflexible and do not maximize their returns.

Furthermore, because these rebate programs are not used, they are not bundled with other, additional services. In this way, the opportunity to augment the payment with additional services is lost. What is needed is the ability to offer augmentation of payments with other services where rebate and other programs are invoked.

### SUMMARY OF THE INVENTION

In accordance with the invention, buyers receive variable early-payment rebates from a supplier over a fixed period, and these may be combined with additional performance-based and other rebates or services. The buyer receives these rebates on a per-transaction basis. The amount of the early-payment rebate is larger the earlier the buyer pays in full before a contractual due date. Along with this payment transaction, value-added services can be combined and provided to each transaction. For example, based on this minimum-volume purchase, the buyer is able to acquire other services on a per-transaction basis, services such as insurance, accrual of amounts for reporting purposes, withholding of various taxes from payments, commodity-related pricing services and foreign-exchange transactional services. If the buyer's national currency has a favorable exchange rate in relation to the supplier's national currency, the buyer's payment may be exchanged for the supplier's currency before payment. These value-added services can be provided by third parties, who may be specialists in the relevant service provision and will benefit from the prospective, aggregation of transaction volumes.

In a first aspect, a method of applying services to an individual transaction between a buyer and a seller includes determining, on a computer system, services based on aggregate prospective transactions between a buyer and a supplier, wherein the services include a variable early-payment rebate service and applying, on the computer system, the services individually to each transaction between the buyer and the supplier, wherein the services are purchased in aggregate. The services are selected by the buyer and include a volume-discount service, a foreign-exchange service, an insurance service, a commodity pricing service, or any combination thereof. In one embodiment, the services are provided by a third party. Typically, the earlier in an invoice payment cycle the buyer settles its account with the seller, the larger its rebate.

The method also includes reporting statistics relating to the early-payment rebates, relating to the services, or relating to both the early-payment rebates and services. The statistics include a summary of insurance coverage or foreign-exchange rate translation savings over a period selected by the buyer, a summary of rebates over a period organized by invoice, product category, or any combination thereof.

In a second aspect, a system for applying one or more services to transactions between a buyer and a supplier include a database for storing invoices corresponding to transactions between the buyer and the supplier, one or more services based on prospective aggregate transactions between the buyer and the supplier, and a financial transaction services engine configured to apply selected ones of the one or more services individually to each transaction between the buyer and the supplier. The system includes a configuration file correlating each of the invoices with selected services. The services include, for example, a variable early-rebate service and a volume-discount service, wherein the variable early-rebate service is based on a number of days an actual payment-in-full date precedes a payment-in-full due date. Other examples of services include an insurance service, a foreign-exchange service, and a commodities service.

In one embodiment, the system also includes a report generator configured to generate one or more reports relating to the rebates, to the one or more services, or to both the rebates and the one or more services.

### BRIEF DESCRIPTION OF THE DRAWINGS

The following figures are used merely to describe illustrative embodiments and are not meant to limit the invention. In the figures, the same label refers to an identical or similar element.

FIGS. 1A-D are graphs of early-payment rebate schedules, used to illustrate different embodiments of the invention.

FIG. 2 shows the steps of a method of processing a transaction in accordance with one embodiment of the invention.

FIG. 3 shows the components of a system for processing transactions and generating reports in accordance with one embodiment of the invention.

FIG. 4 shows a network-based system for processing transactions and generating reports in accordance with one embodiment of the invention.

FIG. 5 shows a table of payment restrictions in accordance with one embodiment of the invention.

FIG. 6 is a use case diagram for the interaction between a buyer, a supplier, and a system for calculating and applying variable early-payment rebates in accordance with one embodiment of the invention.

FIGS. 7-9 are process flows for authorizing and processing transactions in accordance with different embodiments of the invention.

FIGS. 10A-C show reports summarizing the results of a rebate program in accordance with embodiments of the invention.

FIG. 11 shows a system for generating rich analytics in accordance with one embodiment of the invention.

FIG. 12 shows the steps of a process for augmenting financial transaction services in accordance with one embodiment of the invention.

FIG. 13 shows a system for augmenting financial transaction services in accordance with one embodiment of the invention.

FIGS. 14A and 14B show, respectively, an invoice and a portion of a configuration database used to illustrate the principles of the invention.

FIG. 15 shows a use case diagram for applying augmented services to a financial transaction in accordance with the principles of the invention.

FIG. 16 shows a process flow for applying augmented services to a financial transaction in accordance with the principles of the invention.

FIG. 17 is a process flow for a typical credit-card transaction.

FIGS. 18-20 show process flows for a closed-loop credit-card transaction in accordance with different embodiments of the invention.

FIG. 21 shows the steps of methods of processing a closed-loop credit-card transaction in accordance with one embodiment of the invention.

### DETAILED DESCRIPTION OF THE PREFERRED EMBODIMENT

This application describes systems and methods of processing commercial transactions. The first part of this application describes a flexible early-payment rebate system that applies flexible rebates on a per-transaction basis. The second part describes an augmented services platform that augments commercial transactions by applying them to such things as foreign exchange and insurance. The third part describes a closed-loop payment system that, among other things, eliminates interchange fees. It will be appreciated that the different aspects of the inventions can be practiced separately or together. For example, a single system in accordance with the principles of the invention applies flexible early-payment rebates, augments these transactions with selected services, such as favorable foreign-exchange rates, and offers the package in a closed-loop payment system that eliminates interchange fees. Preferably, all of the services take place in the cloud and can thus be hosted on a third-party platform that may be outsourced. Furthermore, suppliers can connect to a single platform that exchanges data with other services, thereby providing a single connection to data processing services such as those offered by Ariba, SAP, and OB-10. The system is able to provide reports and analysis detailing the savings generated by the rebates and other services.

### Variable Early-Payment Rebates

In accordance with present invention, a buyer and a seller, either directly or through a third party, negotiate a purchase agreement with flexible early-payment terms. Under the agreement, volume-based rebates are calculated and captured before or when an invoice is paid. In other words, the rebates are provided prospectively, on a per-transaction basis, rather than retrospectively in aggregate. Detailed reports can then be provided to buyers, sellers, and any other parties involved in the purchase transaction relationship. The accompanying analysis and reporting enables visibility and transparency for each transaction, making reconciliation easier, and enables the entire service to be performed by a third party.

The agreement can include purchase restrictions that limit, for example, the types of products purchased, the total dollar amount of a purchase, and the suppliers. Under some agreements, buyers can also purchase services such as insurance for the products and a service to search for an optimal foreign exchange service and rate. With these features, buyers are more likely to use the early-payment program and, as a result, sellers will receive more early payments.

In practice, a corporation (client) will establish a service provider relationship with a service and pass accounts payable information (invoices ready for payment) to it, over a network connection. The client will configure the service for each relevant supplier, to determine which rebates will be applied, to which products and product categories, at specified times. As one example, a 2% rebate may be applied only to purchases of gauze from company ABC, from Aug. 1, 2013, to Aug. 15, 2013. The rebate will be calculated for and applied individually to each invoice that meets these criteria. The rebates will be applied before or during the payment process. Other examples of configurations of services are described below.

As one example, a purchase agreement having a flexible or varying rebate is negotiated between a buyer and seller. The buyer receives one rebate if it pays in full 10 days before the full-payment due date, a better rebate if it pays in full 15 days before the due date, and a still better rebate if it pays in full 20 days before the due date.

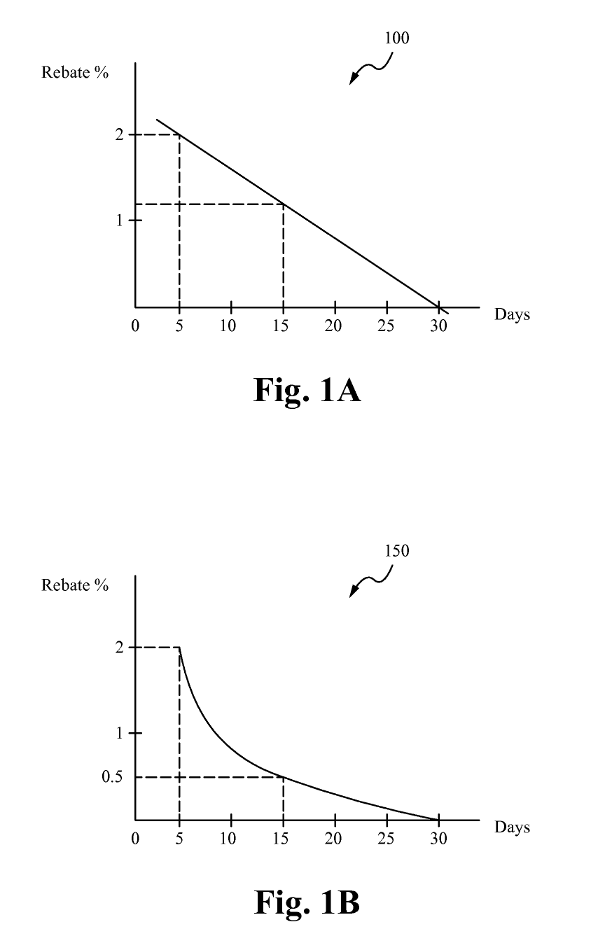

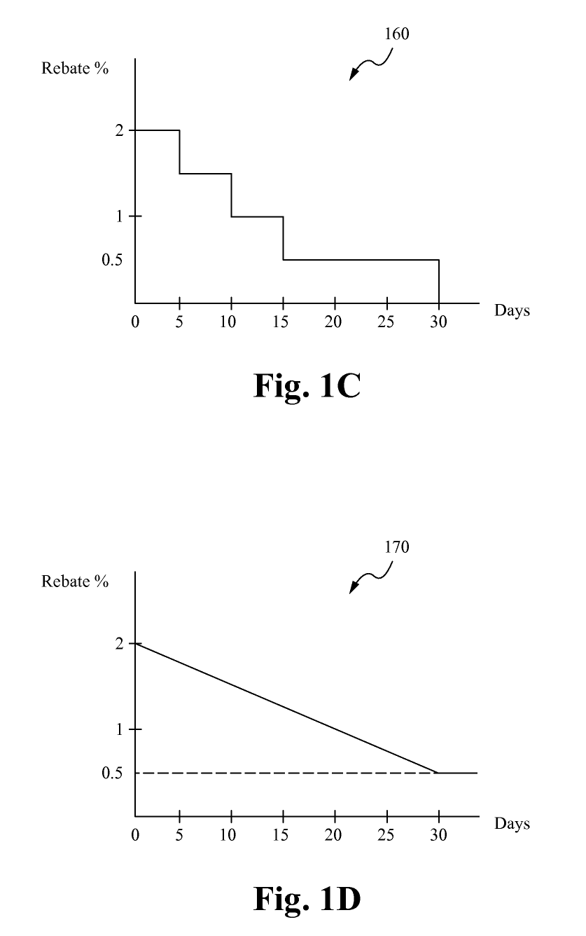

FIG. 1A is a graph 100 of a rebate versus days, illustrating a flexible rebate schedule in accordance with one embodiment of the invention. The graph 100 plots rebate versus days, with the days axis running from 0 (when a buyer receives an invoice) to 30 (the full-payment due date). The period from day 0 to day 30 is called the “invoice payment cycle.” As shown in the graph 100, if the invoice is paid in full by day 5, that is, 25 days before the full-payment due date, the buyer receives a 2% rebate. If the invoice is paid in full by day 15, the buyer receives a 1% rebate. The rebate continues linearly along this continuum. In other words, the rebate varies inversely with a number of days into the invoice payment cycle the account is paid in full. While the graph 100 is linear, it will be appreciated that the parties can negotiate different rebate schedules reflected in different graphs. For example, FIG. 1B shows a graph 150 having a non-linear relationship, in which rebates decrease at an accelerated rate. The schedules 100 and 150 describe “dynamic” rebates. FIG. 1C shows a graph 160 in which rebates decrease over time on a “tiered” or “stepped” basis. And FIG. 1D shows a graph 170 in which multiple rebates (one fixed at 0.5% regardless of time, plus one linearly decreasing rebate) are calculated on a compound “fixed plus variable” basis.

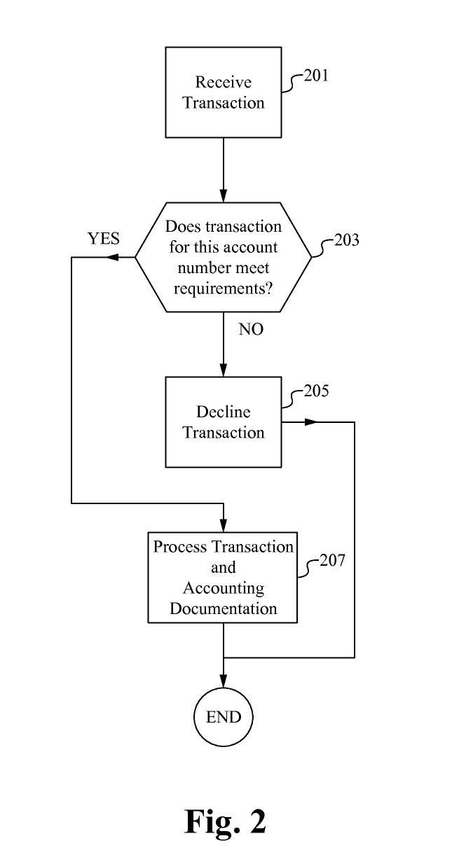

FIG. 2 is a high-level flow chart of steps 200 for a method of applying rebates in accordance with one embodiment of the invention. In the step 201, a transaction is received, such as on an electronic processing platform. The transaction is identified, in part, by an account number related to the individual buyer. In the step 203, it is determined whether the transaction for the particular account number satisfies the purchase restrictions, for example, whether the transaction is for less than a specified dollar amount. If it does, the method proceeds to the step 207, where the transaction is processed; otherwise, the method proceeds to the step 205, where the transaction is declined. As described in more detail below, in the step 207, the transaction can be processed by calculating a rebate, applying any augmented services, proposing a payment, executing the payment, generating appropriate accounting and tax documentation, or any combination of these steps. A payment may be proposed, for example, for payment by a third-party such as a bank. From both the steps 205 and 207, the method proceeds to the step 209, where it ends.

The steps 200 are merely illustrative of one embodiment. In other embodiments, as with all the flow charts in this disclosure, some of the steps can be deleted, other steps can be added, and the steps can be performed in different orders.

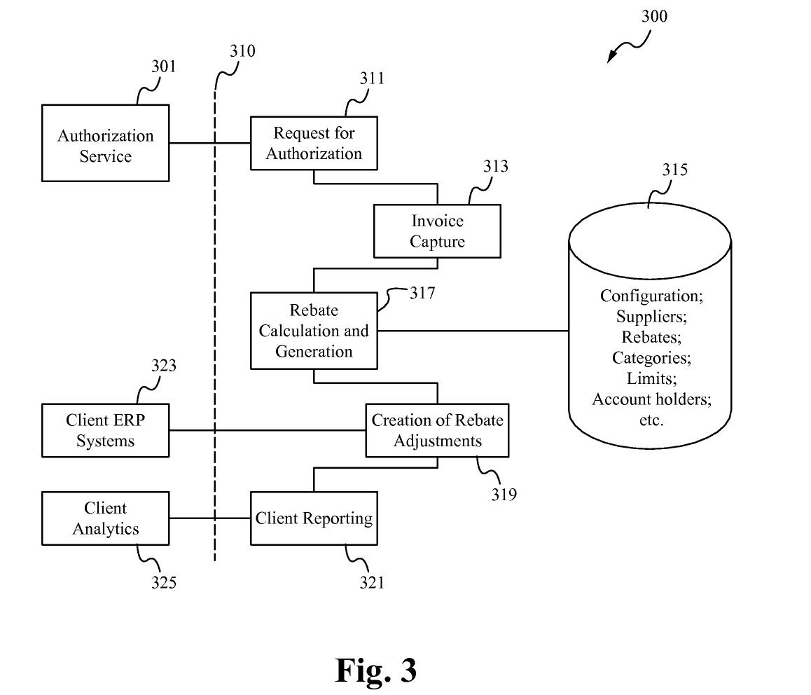

In one embodiment, rebate calculations and related operations are performed on a third-party service platform (a party other than the buyer or the seller) that communicates with both buyer-side and seller-side systems. FIG. 3 shows a process flow 300 for determining rebates in accordance with one embodiment of the invention, with the left side of a dashed horizontal line 310 showing those steps (301, 323, and 325) that occur on the buyer side and the right side of the line 310 showing those steps that occur on the service platform. In the step 301, a user or component on the client side calls a third-party authorization service to request authorization for a purchase, which the platform performs in the step 311. In the step 313, an invoice for the purchase is captured and in the step 317 a rebate is calculated and generated using configuration and account data stored in a database 315. The result of the step 317 is used to generate rebate adjustments in the step 319. Optionally, client reports are generated in the step 321, which in turn are used to produce client analytics in the step 325. The rebate adjustments are also input to client Enterprise Resource Planning (ERP) systems in the step 323.

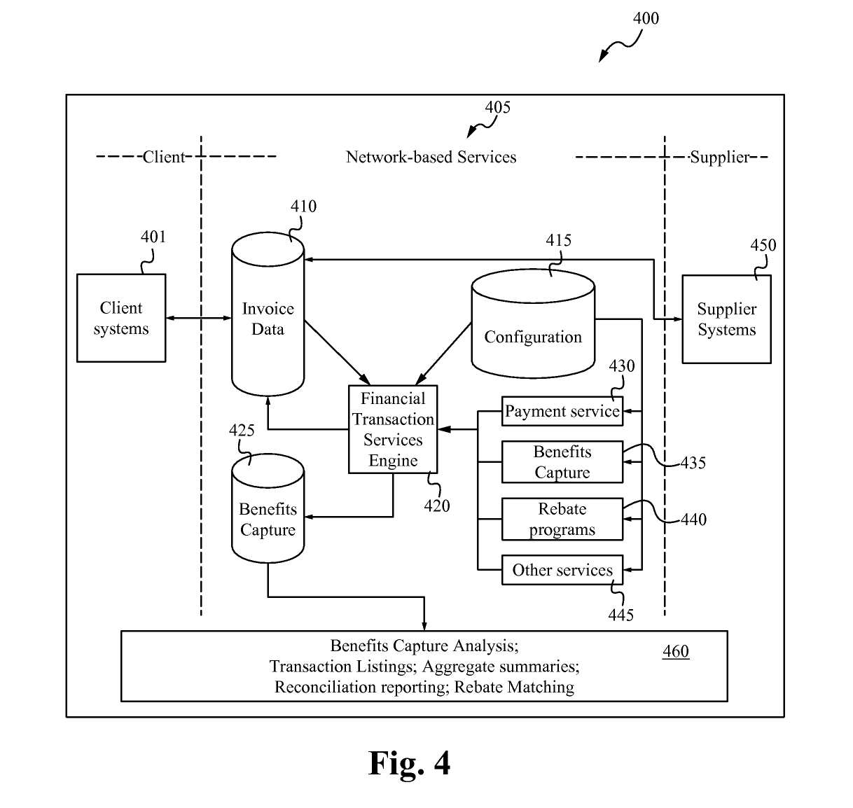

In one embodiment, the buyer-side systems, seller-side systems, and financial transaction platform are all coupled together over a network, such as shown in the networked financial services system 400 in FIG. 4. The system 400 includes client systems 401, supplier systems 450, and a financial transactions platform (FTP) 405. The platform 405 includes an Invoice database 410, a configuration database 415, a financial transaction services engine (FTSE) 420, a Benefits Capture database 425, a payment service 430, a benefits capture service 435, a rebate programs module 440, an “other services” module 445, and a component 460 for performing benefits capture analysis, transactions listings, aggregate summaries, reconciliation reporting, and rebate matching.

In operation, a buyer configures a rebate option on the platform 405 for a specific client (or buyer), supplier, and product (or product category), of a certain rate, in this example a flat rebate of 2.25%. The suppliers' system 450 submits an invoice for $10,000, representing 100 units of a product X at a unit price of $100 each. The invoice is stored in the Invoice database 410. The client systems 401 authorize payment of the invoice. The FTSE 420 reads configuration data in the Invoice database 410 to determine, for example, the rebate schedule, any purchase restrictions, and any other services that should be applied to the transaction. The FTSE 420 determines whether the purchase is allowed, for example by determining that purchase restrictions are met, and if they are, it invokes a rebate program 440 to calculate and apply any variable early-payment rebates, invokes any other services 445, invokes the “benefits capture” service 435 to capture all the benefits on the single transaction, that is, on a per-transaction basis, and invokes the payments service 430 to pay or authorize payment to the supplier. The benefits captured (e.g., rebates and other calculated net values) are stored in the Benefits Capture database 425, which can then be analyzed by the component 460 to generate listings, aggregate summaries, reconciliation reporting, rebate matching, and the like. Rebates are calculated for this and other appropriate invoices, typically in a daily batch or on an on-demand basis. The calculated net amounts can be passed to other services (e.g., 445), including early-payment services. On an on-demand or periodic basis, the benefits capture service 445 will provide detailed and summary reconciliation reports for the buyer and the seller. These reports assist with quantifying the total rebate earned and reconcile how calculations relate to each product and invoice.

Some embodiments, when determining rebates, account for regional tax laws. For those transactions that occur in countries that levy a value added tax (VAT) on each transaction, the invoice price and rebate are adjusted to account for the VAT. A similar adjustment is made for transactions that occur in countries that levy a sales tax. These adjustments are included in the detailed reports generated by the module 460.

In some embodiments, the platform 405 is hosted by a third party, which can charge a percentage of the benefits (e.g., rebates and foreign-exchange savings) as its services fee. The rebate system is thus “performance based” for both the buyer and the third party, in that both increase their profits the earlier the buyer pays.

In a preferred embodiment, the platform 405 includes a computer-readable medium storing computer executable instructions and one or more processors for executing those instructions. The computer-executable instructions perform, for example, the method steps 200 and 300 and any other steps performed by an FTSE and an FTP as described herein.

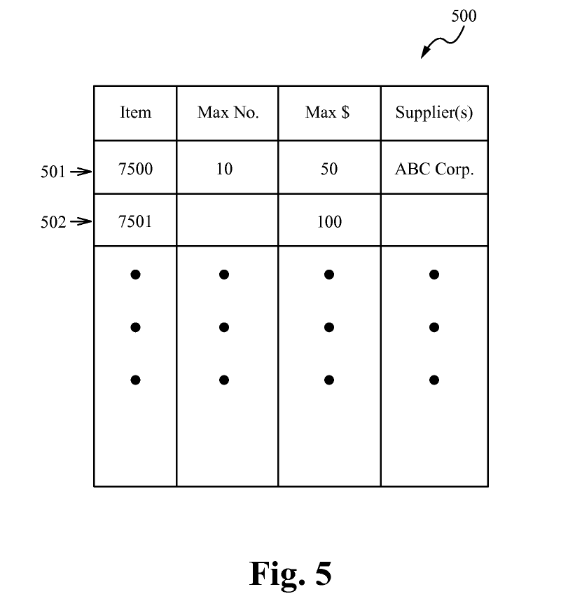

FIG. 5 shows a table 500 storing records 501, 502, etc. of purchase restrictions in accordance with one embodiment, such as stored in the Configuration file 415 for electronic processing. The table 500 is queried, for example, in the step 203 in FIG. 2. The rows in the table 500 include an item or product number field (column 1), a maximum number field (column 2), a maximum dollar amount field (column 3), and an approved supplier field (column 4). In this example, if a particular field is empty, it has no restrictions. Referring to the exemplary record 501, bandages (indicated by code 7500, column 1) have restrictions of a maximum number of 10 (column 2), a maximum dollar amount of $50 (column 3), and a restricted supplier, ABC Corp. (column 4). In other words, for a purchase of bandages (column 1) to be eligible for a rebate, no more than 10 can be purchased in a single transaction (column 2), for a total purchase price of no more than $50 (column 3), and can only be purchased from ABC Corp. (column 4). If the table 500 does not contain a product code, then that product is not covered by this particular rebate program. Thus, the purchase restriction stored in record 502 indicates that gauze (product code 7501) has no restrictions on the number for purchases but is limited to a total purchase price of $100.

It will be appreciated that the table 500 is used merely for illustration. Tables with other formats and with more or less information can be used in accordance with the present invention. Furthermore, while many of the examples discuss purchasing products, it will be appreciated that services can also be purchased under rebate programs in accordance with the invention.

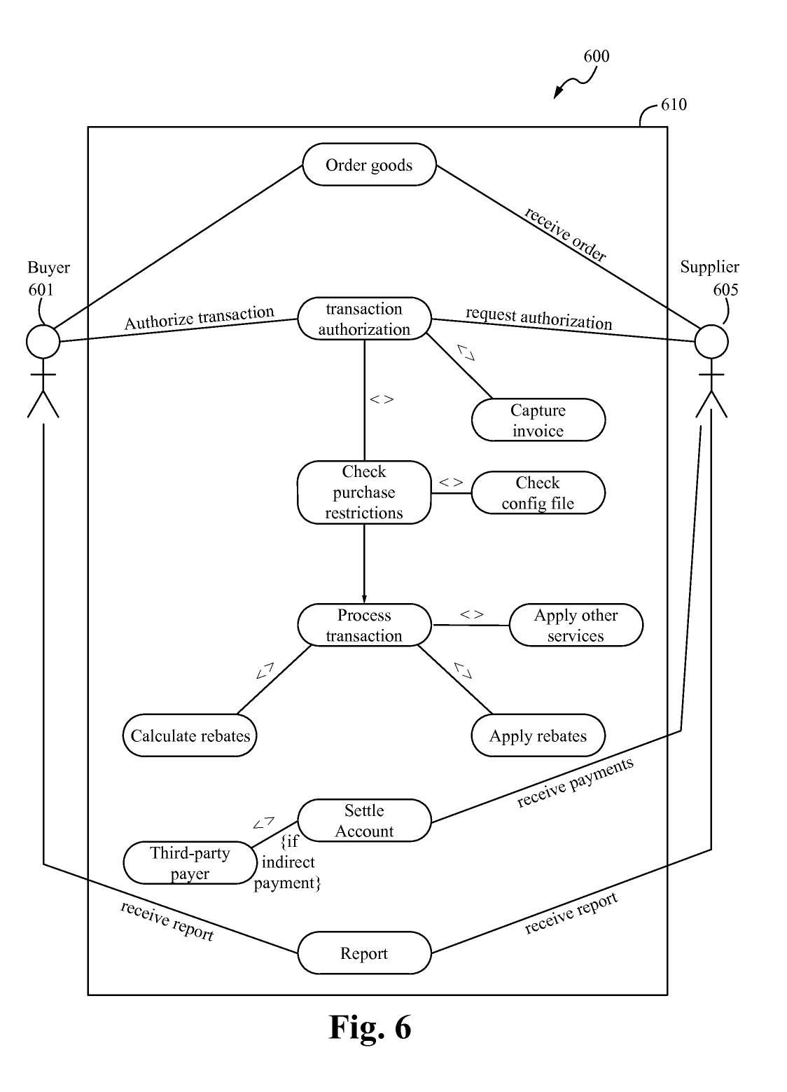

FIG. 6 is a use case diagram 600 illustrating the interaction between a buyer 601, a supplier 605, and an FTSE platform 610 for processing transactions in accordance with one embodiment of the invention. Those skilled in the art will recognize that paired angle brackets (<>) indicate “extending” an action. The use case diagram 600 shows that when the buyer 601 orders goods, the supplier 605 receives the order. The supplier 605 requests authorization of the transaction, and when the buyer 601 responds with an authorization, the platform 610 captures the invoice and checks purchase restrictions, which are found, for example, by querying a configuration database. The platform 610 processes the transaction by calculating the rebates and applying them and any other services to the transaction. The account is settled by the buyer paying the supplier directly or by instructing a third party to do so. The system can generate reports for both the buyer and the supplier.

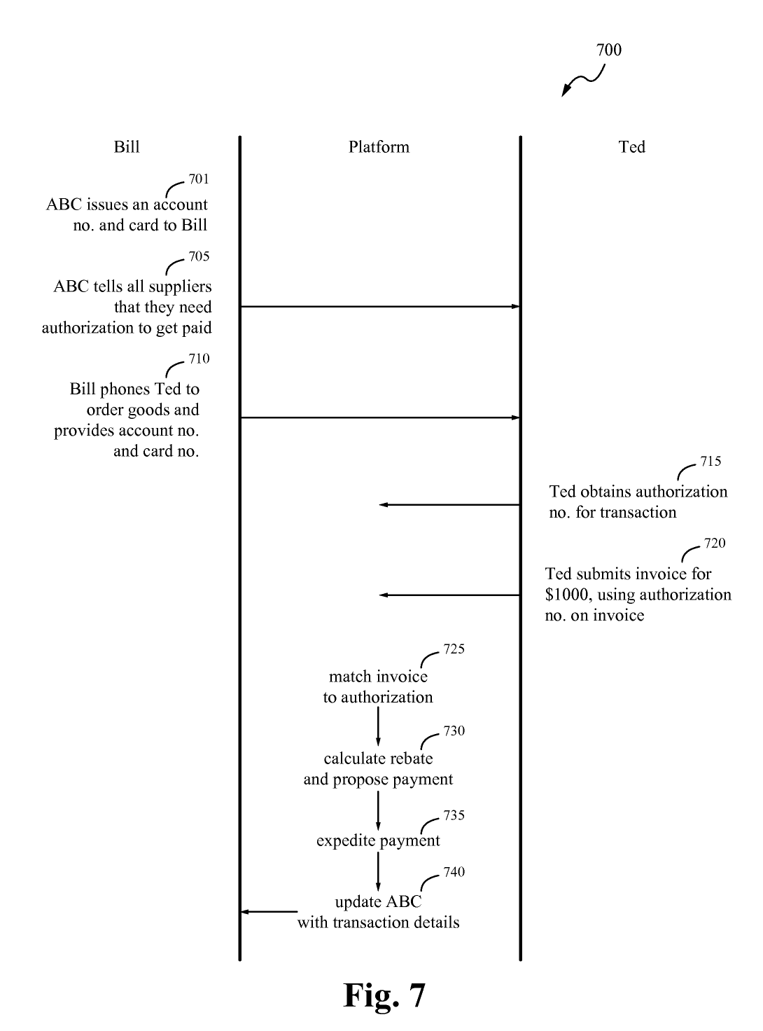

FIGS. 7-9 are process flow diagrams for different scenarios, illustrating how rebates are calculated and applied for different types of spend in accordance with the principles of the invention. In these examples, authorizations take place before any transaction processing enters the network. In these examples, Bill, an employee of company ABC, is issued a rebate card or account number (described in more detail below) for making purchases under a purchase agreement, such as discussed above. Each rebate card has a company account number that identifies the company and a card number that identifies, among other things, a particular employee of the company, such as Bill.

Referring to FIG. 7, ABC issues a rebate card to Bill (701). ABC may notify all suppliers that they must have an authorization number to get paid for any transactions (705). Bill telephones a supplier, Ted, and makes a purchase, providing the company and card account numbers (710). Ted obtains an authorization number for the transaction (715) and, using the authorization number, submits an invoice for the amount of the transaction (720). The financial transactions platform (FTP) matches the invoice to the authorization (725), calculates the appropriate rebate(s) and proposes a payment (730). The FTP expedites the payment (735) and updates ABC with the transaction details (740).

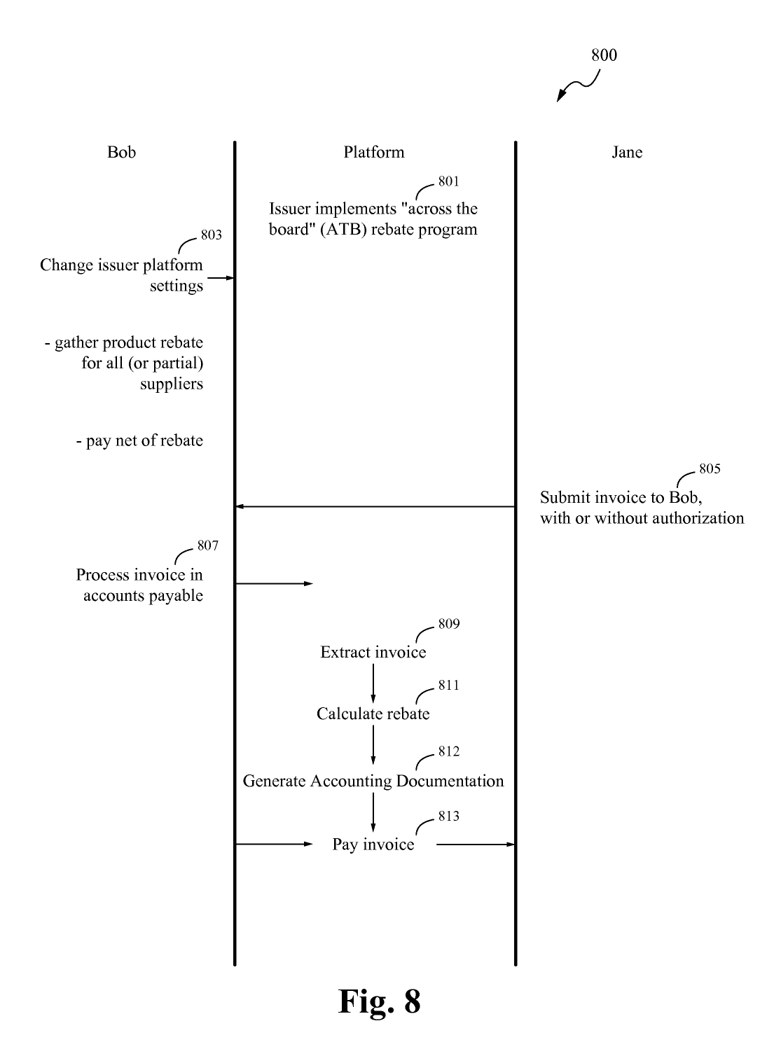

FIG. 8 shows a process flow 800 for an “across the board” (ATB) rebate program. In this example Bob, the CFO of company ABC, wants to generate profit-and-loss savings en masse. Bob asks an issuer to implement the ATB rebate program, which will be limited to (for example) consumables only. The issuer implements the ATB rebate program (801) with purchase restrictions for Bob. ABC changes the issuer's platform settings (803) by (a) gathering product rebates (e.g., 3%) for all supplies or partial supplies and (b) paying the invoices presented net of rebates. Jane, an employee of the supplier XYZ, submits an invoice to Bob, with or without authorization (805). Bob processes the invoice in accounts payable (807). The FTP extracts the invoice (809), calculates the rebate(s) (811), generates the appropriate accounting and tax documentation (812), and pays the invoice (813).

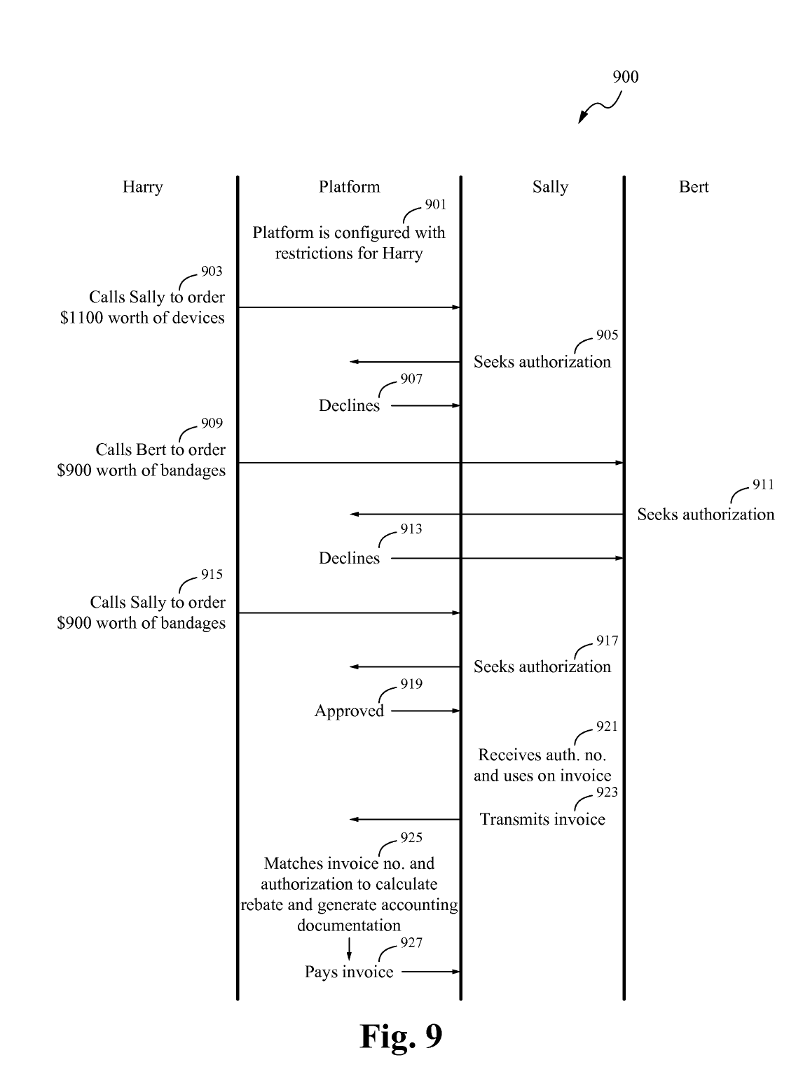

FIG. 9 shows a process flow 900 using purchase restrictions in accordance with embodiments of the invention. In this example, Harry, an employee of ABC, is restricted to certain products, suppliers, and dollar amounts (901): Harry can buy only bandages and devices from the supplier Sally; Harry can buy only medical supplies from the supplier Bert; Harry cannot make any single transaction over $1,000; and Harry's total transactions in one month cannot exceed $10,000. As explained in detail below, these restrictions can be stored in a configuration or other database for electronic processing.

Referring to the flow 900, Harry calls Sally to order $1,100 worth of devices (903). Sally receives this order and requests authorization (905). Because this transaction is for more than $1,000, the request is declined (907). Harry calls Bert to order $900 worth of bandages (909). Bert receives this order and requests authorization (911). Because Harry is not authorized to order bandages from Bert, this request is declined (913). Harry again calls Sally, this time to order $900 worth of bandages (915). Sally receives this order and requests authorization (917). This time, because Harry is authorized to order $900 worth of bandages from Sally, this request is approved (919). Sally receives an authorization number and places it on her invoice (921), and transmits this invoice for processing (923). The FTP matches the invoice number and the authorization to calculate the rebate and generates accounting and tax documentation (925), and then pays the invoice (927).

It will be appreciated that the process flows 700, 800, and 900 are merely illustrative. As one modification, in the process flow 900, ABC rather than the FTP pays the invoice in the step 927. Those skilled in the art will recognize other modifications that may be made in the spirit of the invention.

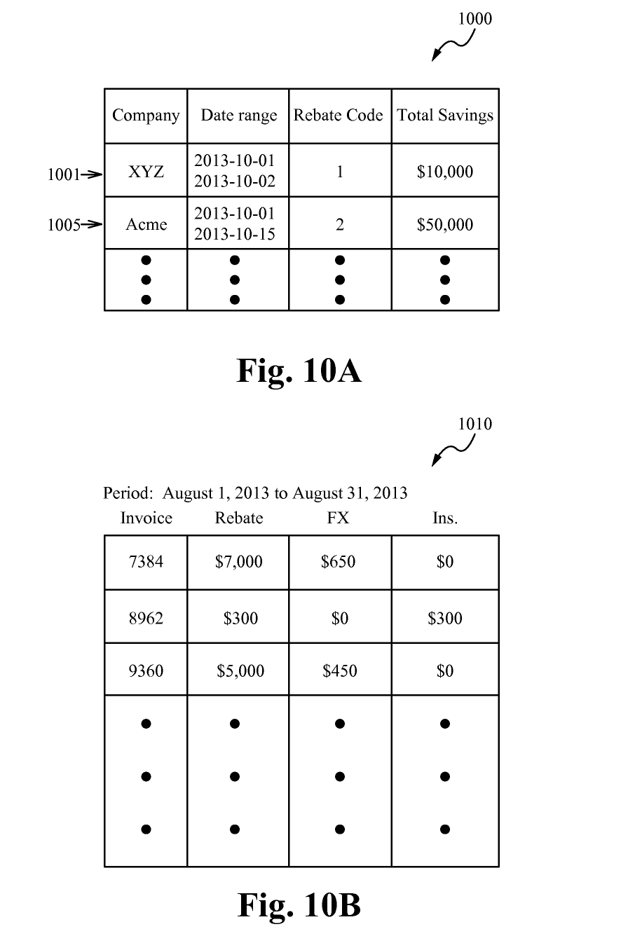

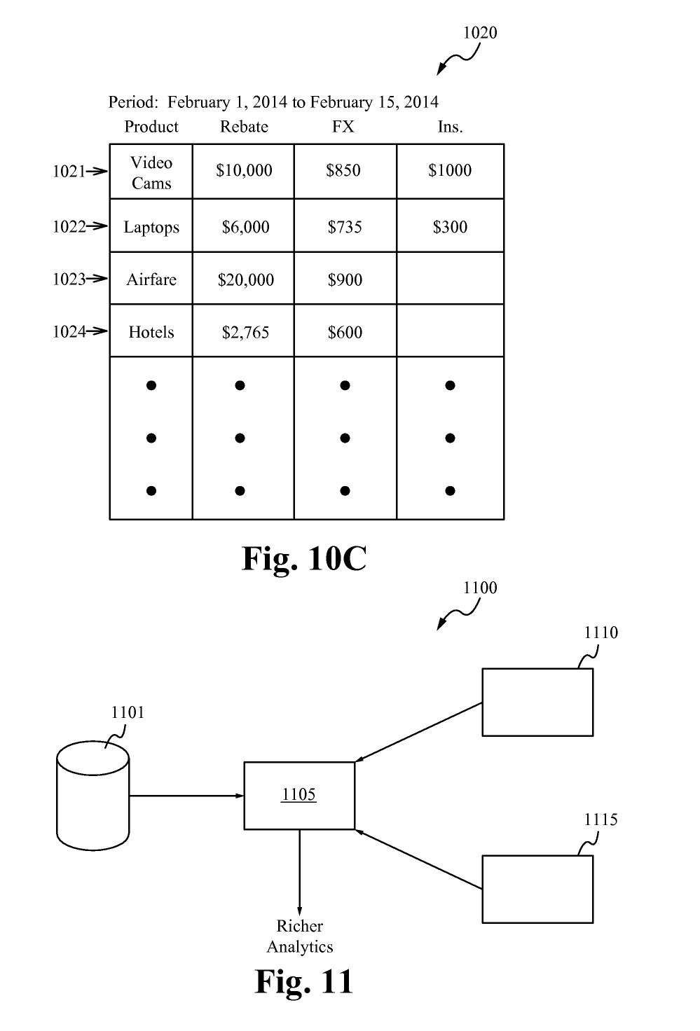

Analytics for the rebate program can be generated to track total savings and determine which rebate programs, among many implemented by a company, are most profitable or have the highest impact in the buyer, supplier or buyer-supplier relationship. As one example, the FTP generates reports that show savings generated, organized by user-selected purchasing period, invoice, or products. Both the buyer and the seller can generate these reports for analysis. FIG. 10A shows a report 1000 generated in accordance with one embodiment of the invention, using invoice data and corresponding rebates. The report 1000 contains the records 1001 and 1005. The user-selected fields include company (column 1), date range (column 2), rebate code (column 3), and total savings (column 4). The exemplary record 1001 shows that for products purchased from company XYZ (column 1), for the period from Oct. 1, 2013, to Oct. 31, 2013 (column 2), rebates were calculated using a rebate code 1 (column 3) totaling $10,000 dollars (column 4). The rebate code 1 can, for example, correspond to the rebate graph 100 in FIG. 1A.

The record 1005 shows that for products purchased from company Acme (column 1), for the period from Oct. 1, 2013, to Oct. 15, 2013 (column 2), rebates were calculated using a rebate code 2 (column 3) totaling $50,000 dollars (column 4). The rebate code 2 can, for example, correspond to the rebate graph 150.

FIG. 10B shows a report 1010 summarizing the savings, organized by invoice, accrued by the different augmented services for the user-selected period from Aug. 1, 2013, to Aug. 31, 2013. The report 1010 lists, for each invoice (column 1), the savings accrued by the variable early-payment rebate services (column 2), the foreign-exchange service (column 3), and the insurance service (column 4). For example, row 1 shows that for invoice 7384, the variable early-payment rebate service generated savings of $7,000 and the foreign-exchange program generated savings of $650. The insurance service did not save any money because no items were lost or damaged. Similarly, referring to column 2, for the invoice 8962, the variable early-payment rebate service saved $300, the foreign exchange service saved 0 dollars (e.g., a domestic sale), and the insurance service saved $300. Data for other invoices are similarly explained.

FIG. 10C shows a report 1020 summarizing the savings, organized by product, accrued by the different augmented services for the user-selected period Feb. 1, 2014, to Feb. 15, 2014. The report 1020 lists, for each product (column 1), the savings accrued by the variable early-payment rebate service (column 2), the foreign-exchange service (column 3), and the insurance service (column 4). For example, row 1021 shows that for purchases of video cams, the variable early-payment rebate service saved $10,000, the foreign-exchange service saved $850, and the insurance service saved $1,000. Similarly, referring to column 1023, for laptops, the variable early-payment rebate service saved $6,000, the foreign exchange service saved $735, and the insurance service saved $300. Data for other products are similarly explained.

The records 1000, 1010, and 1020 are merely illustrative. Users, such as buyers and sellers, can select other fields to include in reports.

Data stored in a transactional (e.g., invoice) database can be combined with one or more other analytical sources to generate rich analytics. For example, data about a buyer's purchases can be combined with data from a first outside source to produce a first set of rich analytics and then combined with data from a second outside source to produce a second, richer set of analytics. This process can continue for any number of outside sources.

FIG. 11 shows a system 1100 for generating rich analytics in accordance with the principles of the invention. The system 1100 includes a transactional database 1101, a first outside source 1110, (e.g., a salesforce.com® module), and a second outside source 1115, which contains product information for certain products, all coupled to an analytics generator 1105. The database 1101 contains information about an employee Bob's purchase of a video cam. The first outside source 1110 contains information used to track the recruitment of suppliers to the platform and includes more specific information about Bob, such as his zip code, his credit score, and the size of the company he works for. The second outside source 1115 contains product information about video cams, for example market trending data indicating that video cams are becoming less popular. The generator 1105 combines these data to, among other things, predict Bob's future purchases and make purchasing suggestions to him.

As another example, data can be augmented in order to support further analysis beyond the core transaction data. For example, when the invoices in the database 1101 are processed, they can be tagged with extra attributes. In this example, an invoice number may contain an invoice number (123), a product (video cam), a manufacturer (Sony), and a date of purchase (2013-10-12). As this invoice is processed, it can be tagged with extra attributes, providing richer analytics that can be used, for example, to generate aggregate trend information. These richer analytics can be used to predict purchasing price indexes, which correlate consumer purchases with consumer confidence.

It will be appreciated that the system 1100 can form part of an FTP or it can be a separate component that communicates with an FTP.

Those skilled in the art, with the benefit of this disclosure, will recognize other analytics that can be generated using the principles of the invention.

### Augmenting Transaction Services

In accordance with the invention, any number and combinations of financial transaction services can be bundled with a variable early-payment rebate service. These value-added services may be applied to individual transactions as each transaction is processed. In this way, businesses are able to outsource their enterprise processes and create combinations of services that were previously impossible to do with network-based platforms.

As one example, foreign exchange rates are typically better when larger amounts of currency are being bought and sold. In accordance with the invention, foreign exchange can be purchased in aggregate during the integrated payment and conversion process, taking the aggregate value of all relevant foreign-currency transactions as the basis of obtaining a better rate. Similarly, the allocations of volume-based rebates to individual transactions enable better and more transparent reconciliation of supplier accounts: This is more easily performed using the principles of the invention and may also be outsourced, since all of the information is transparently available and can be shared (under an appropriate service level agreement) with a third-party service.

In operation, a corporation (the client) establishes a service-provider relationship with an FTP and passes accounts payable information (invoices ready for payment) to the FTP. These invoices originate from the supplier, who also has visibility to its transactions, and they pass through the augmented financial transaction services engine (AFTSE) to determine which (if any) additional financial transaction services will be invoked at the same time as the payment service. These include, but are not limited to, insurance, foreign-exchange conversion, commodity pricing and hedging services, accruals, early-payment rebate calculations, and volume-discount rebate calculations, to name only a few such services. When the payment process is run, the augmented financial transaction services will be performed as required on each payment transaction and recorded in the FTP Invoice database for subsequent action and processing by the FTP and the client.

In this example, a buyer has purchased several augmented services to apply to each transaction. For example, the buyer may select insurance coverage and foreign-exchange conversion for each transaction. Using the insurance, a product purchased is covered if, for example, it is lost, stolen, or damaged, or there are discrepancies between the number of items ordered and the number shipped, and there is no subsequent way to address the dispute in conventional business-to-business methods such as issuing a credit note or refund. Using the foreign-exchange service, if the buyer is a U.S. corporation and the supplier is a Japanese corporation, due to foreign-exchange rates, the buyer may pay less in dollars if it converts its payment from dollars into Yen. The foreign-exchange service will only convert the buyer's payment if the foreign-exchange rate is more favorable to the buyer. The insurance service and the foreign-exchange service are available because the buyer has committed to multiple purchases under the minimum-purchase clause of the purchase agreement. Those skilled in the art will recognize other financial services that can be applied to transactions in accordance with the principles of the invention.

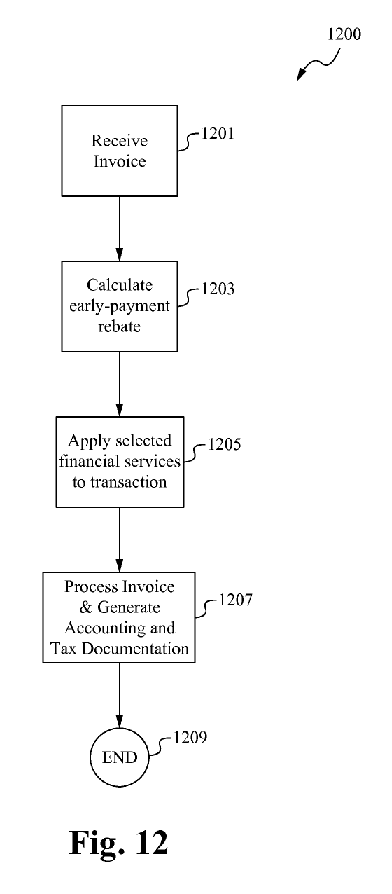

FIG. 12 is a high-level diagram of the steps 1200 of a method of augmenting financial transactions in accordance with one embodiment of the invention. In the step 1201, an AFTSE receives an invoice. In the step 1203, the AFTSE calculates a variable early-payment rebate and applies it to the transaction. In the step 1205, the AFTSE applies selected ones of financial transaction services to the transaction. If one of the services is a foreign-exchange service, this may further reduce the payment made by the buyer. In the step 1207, the invoice is processed, appropriate accounting and tax documentation is generated, and the transaction is settled.

As a more specific example, a client has signed up with the AFTSE. The buyer and seller have a purchase agreement that details rebates and other transaction services. Configuration and integration have been established and the client has made an accounts payable invoice for $1,000 available for payment. The AFTSE processes this payment and produces a payment proposal for presentation to an electronic payment mechanism (such as BACS in the United Kingdom or ACH in the United States). When the payment is executed, the AFTSE invokes these services. First, a rebate of 2% of invoice value is calculated and allocated to the transaction. Next, an accrual for insurance of 0.07% of the invoice value is calculated and withheld from the payment. A volume-based rebate of 1.9% of the invoice value is then calculated and withheld from the payment value. Finally, because this payment is in a foreign currency, an external foreign currency purchase service is invoked with an external bank and the currency amount is purchased dynamically.

This example merely illustrates the principles of the invention. It will be appreciated that the services can be performed in different orders.

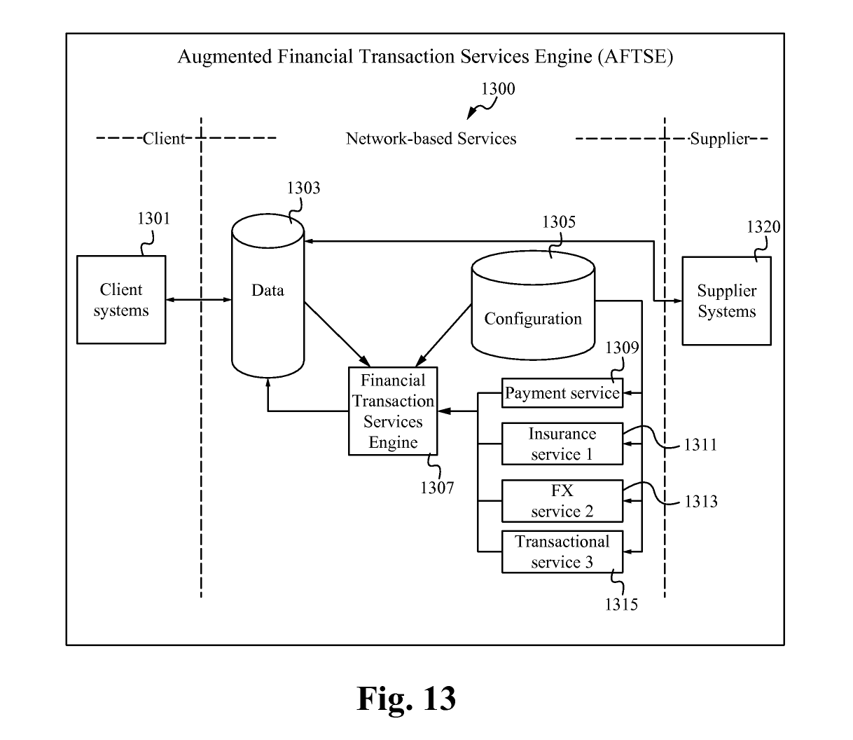

FIG. 13 is a block diagram of an augmented financial transaction services (AFTS) platform 1300 for applying services to financial transactions in accordance with one embodiment of the invention. The AFTS platform 1300 can form part of or be combined with the FTP 405 of FIG. 4. The platform 1300 is coupled to client (buyer) systems 1301 and supplier systems 1320. The systems 1301 and 1320 transmit invoices to the platform 1300 for processing. The platform 1300 includes an invoice database 1303, a configuration database 1305, a financial transaction services engine (FTSE) 1307, a payment service module, 1309, an insurance service 1311, a foreign-exchange service 1313, and another transactional service 1315.

In operation, the supplier systems 1320 submit an invoice to the platform 1300, which stores it in the database 1303. The clients' system 1301 authorizes payment of the invoice. The FTSE 1307 receives an alert that the invoice is ready for processing and then queries the configuration database 1305 to determine what services are to be applied to the invoice. In one embodiment, the invoice number has fields that indicate that the invoice is for a purchase of wheat from a Japanese corporation. The configuration database 1305 contains an entry indicating that variable early payment, insurance, and foreign exchange services should be applied to this invoice. In one embodiment, the configuration database contains fields that map particular invoices to particular services. Using this configuration data, the FTSE 1307 invokes the variable early-payment service 1309 to determine the variable early-payment rebate to apply to the transaction, invokes the insurance service 1311 to apply insurance to the transaction, and invokes the foreign-exchange service 1313 to apply the foreign-exchange conversion service to the transaction. The FTSE 1307 then settles the transaction, such as by paying the supplier 1320 directly or by authorizing a financial institution (e.g. a bank or a service that has made a foreign exchange on the client's behalf) to make payment on its behalf, for which the buyer will later be charged. The FTSE 1307 then updates the database 1303 with the details of the transaction for both the buyer and the supplier to view.

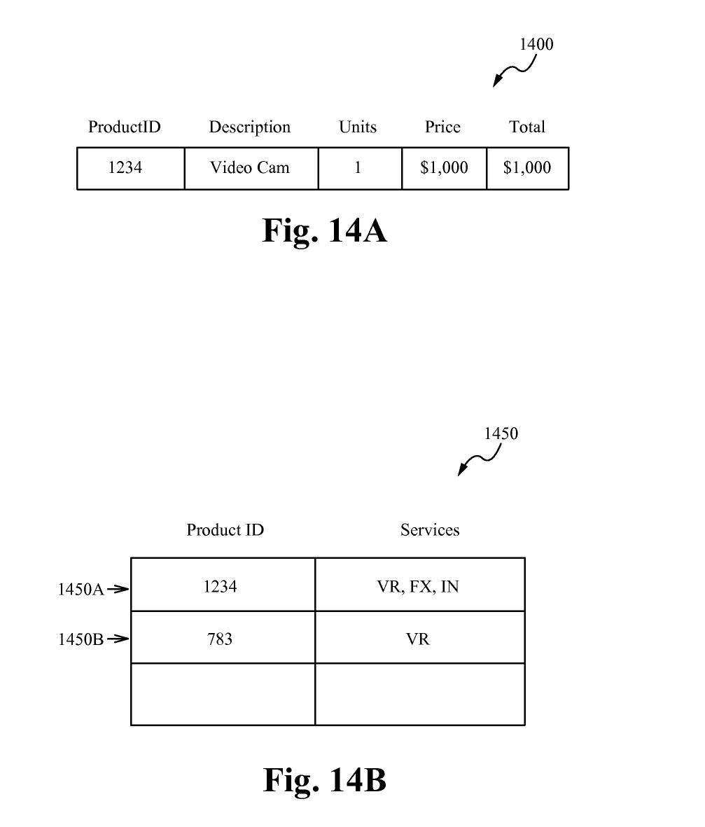

FIG. 14A shows an invoice 1400 stored in an invoice database, such database 1303, in accordance with one embodiment. FIG. 14B shows a portion of a configuration file 1450 containing records 1450A and 1450B stored in a configuration database, such as the configuration database 1305, in accordance with one embodiment. The invoice 1400 includes a product field (“1234”), a description field (“Video cam”), a unit of measure field (“1”), a price field (“$1,000”), and a total field (“$1,000”). The record 1450A maps a product code (“1234”) to specific services (“VR, FX, IN”), and the record 1450B maps a product code (“783”) to a specific service (“VR”), where “VR” indicates variable rebate, “FX” indicates foreign exchange, and “IN” indicates insurance. An FTSE processing the invoice 1400, will use the product code “1234” as an index into the database 1450 to determine that a variable rebate, foreign exchange, and insurance services are to be applied to the invoice 1400 when processing it. The record 1450B shows that an invoice with the product code 783 will have only a variable rebate service applied to it.

It will be appreciated that the invoice 1400 and the database 1450 are merely illustrative. Invoices and configuration databases with other fields and structures can be used in accordance with the principles of the invention.

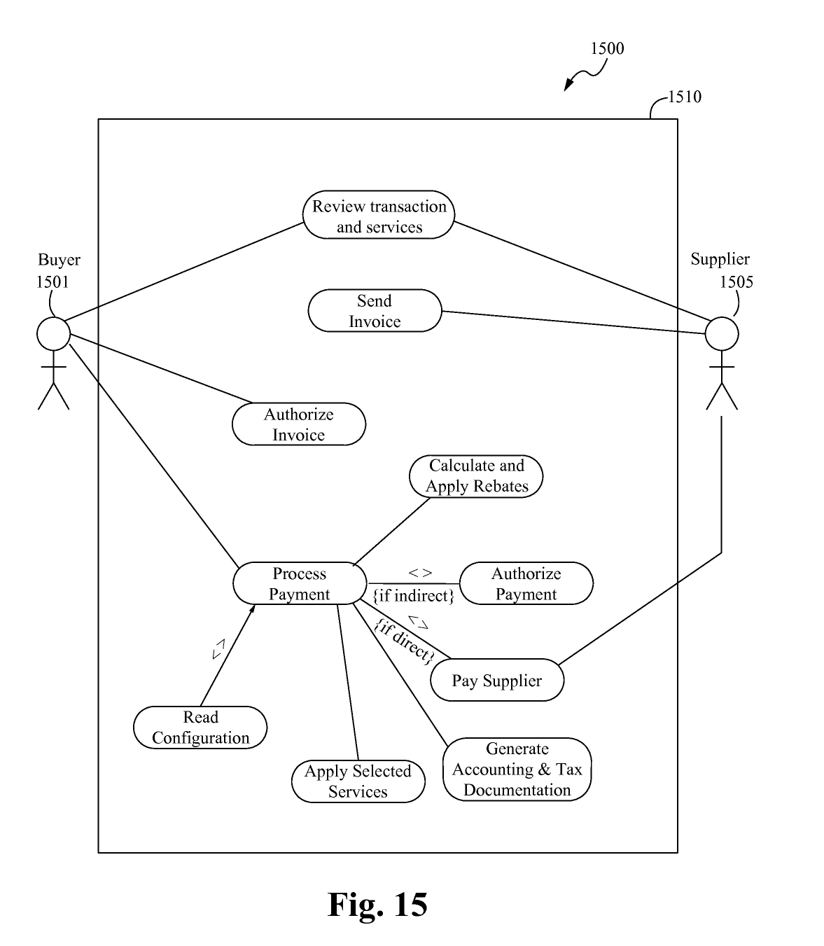

FIG. 15 is a use case diagram 1500 of an interaction between a buyer 1501 and a supplier 1505 using an AFTS platform 1510 in accordance with one embodiment of the invention. As shown in the diagram 1500, the buyer 1501 can receive and authorize invoices and can review transactions and services. The supplier 1505 can send invoices and review transactions and services. The AFTS platform 1510 processes payments, such as by reading configuration files to determine which services to apply to the transactions, and either paying the supplier or authorizing third parties to do so.

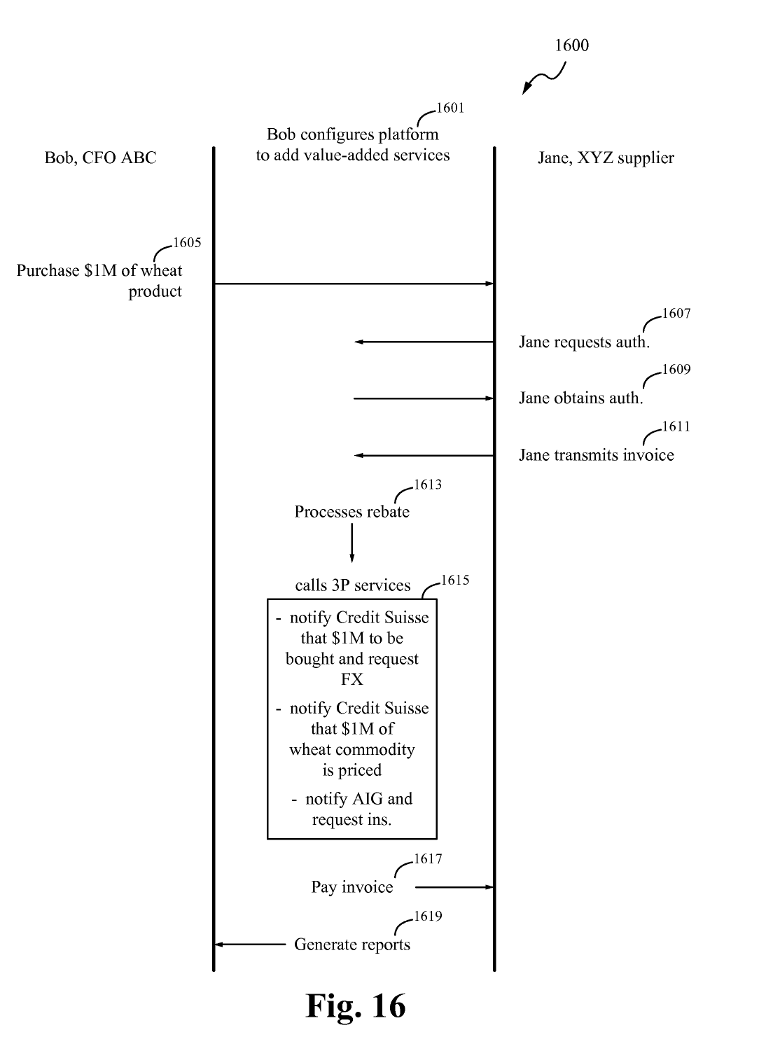

FIG. 16 shows a process flow 1600 of augmenting financial transaction services used to further illustrate the principles of the invention. As shown in the flow 1600, Bob, the CFO of company ABC, configures an AFTS platform to add value-added services (1601). Bob purchases $1 million of wheat for production from Jane, at company XYZ (1605), to be settled in Swiss Francs. Jane receives the purchase request, requests authorization (1607), and obtains authorization for the purchase (1609). Jane transmits an invoice for the purchase (1611), and the AFTS platform processes the invoice by calculating a variable early-payment rebate (1613). The AFTS platform determines any additional services to apply the transaction (1615). In this example, a third-party foreign-exchange service is to be applied, so the AFTS platform automatically contacts Credit Suisse to buy $1 million dollars of Swiss francs. An insurance service is also to be applied, so the AFTS platform contacts AIG to request insurance. The AFTS platform then pays the invoice by, for example, instructing Credit Suisse to deposit Swiss francs into XYZ's account (1617), and generates any reports (1619).

Because many parties—the buyer, the supplier, third party services—must synchronize accounts, it will be appreciated that a master data account, accessible to all parties, may be established and maintained. This master data account may include, for example, invoice numbers, product information, services, deposit account numbers, and the like.

### Closed-Loop Payment Network

In an analogy to existing credit card interchange models, a corporation (“buyer”) is able to establish a closed-loop network, in which the buyer (as a corporation along with individual account holders who are employees of the corporation) becomes an “issuer” of purchasing capabilities, and an “acquirer” of supplier capabilities to connect, receive approvals and authorizations for purchase transactions, and process transactions (invoices) for payment facilitated through the network. This model comprises a closed loop, involving buyer, supplier (called a “merchant” in this model) and the rebate platform. This model eliminates the need for “interchange,” unlike open credit card systems such as VISA® and MasterCard®, who charge interchange fees as part of the mass interoperability service they provide. Lack of interchange means that a buyer can set rates on a number of different bases including (a) cost recovery, (b) charitable donation and Corporate and Social Responsibility (“CSR”), and (c) reasonable commercial basis. Because the closed-loop system is between independent contracting parties, it is not subject to public disclosure statutes enacted in many countries. The model integrates all such services in a single, buyer-owned “closed-loop network” for payment and related services. The model is “closed loop” in that the interactions between the buyer, the merchant, and the financial transaction platform take place within a defined and closed network that includes all transactions such as master data changes, contracting, transaction exchange, authorizations and payments. Finally, because each buyer-merchant relationship is based on independent contracts, the parties are free to negotiate how different card transactions are processed. This differs from current credit-card transactions, which are required by law to be treated the same. For example, some countries force merchants to treat cash and credit transactions the same or prevent merchants from distinguishing between different buyers.

Preferably, all of these services are offered via an online network connection, which does not require the installation, maintenance and operation of packaged software. In this preferred embodiment, the closed-loop business payment network is a “cloud-based” service. Preferably the system uses a direct connection between the merchants and the buyers, obviating the need for electronic point-of-sale (ePOS) transactional terminals, with their rental and upkeep fees.

In a closed-loop network in accordance with the principles of the invention, a corporation (the client) will establish a contractual relationship with the rebate service provider (RSP), which will connect the client electronically with its merchants and exchange accounts payable information, for example, invoices ready for payment and process early payments. In doing so, the RSP codes analogous to credit card numbers (sixteen plus three digits long) will be allocated to purchasing agents (buyer employees) and all merchants as “network identifiers.” Electronic bank information will be recorded for all network participants. Once this network of known buyers and merchants is established (and maintained over time), invoices for payment will be processed, and their subsequent early payments will be executed by the client using the RSP platform: These payments will be made using the network identifiers, thus keeping the exchange of information within this “closed loop” network.

As one example, a client has signed up for the RSP service. The client's merchants will be allocated unique RSP codes (sixteen plus three digits), and any (and all) purchasing agents will also be allocated an RSP code. When Accounts Payable invoices from these merchants are approved, they are passed into the RSP network for payment facilitation. Payments are processed by the RSP service and passed either to banks for electronic payment, or back to the buyer for direct connection to the buyer's banking systems. For some merchants, requiring online authorization of purchases through the RSP network, a request is made at the time of the order which checks rules or restrictions in the closed loop network to check that funds are available for this combination of buyer-merchant, product category, and amount. If this request is approved, then an authorization record will be written to the RSP database, which can be matched at a later stage with an electronic invoice from the merchant.

Because purchase restrictions can be implemented (e.g., certain products can be purchased from only certain merchants), the system reduces or eliminates fraud: An unauthorized user of this closed-loop card, even if he produces sufficient identification at the point of sale, can be restricted from purchasing certain products.

Using this system, a buyer can setup and operate a closed loop business payment network for their purchasing activities and interactions with merchants, without the need to utilize “open access” payment systems.

In accordance with one aspect of the invention, no interchange fees are charged. The system retains a business-to-business invoice cycle, thereby generating invoice documents used for tax purposes, and taking advantage of the timing differential between buying and paying. The buyers can implement the model themselves, with the purchasing and other restrictions and by receiving early-payment rebates, such as discussed above. The buyer can pay a third party hosting this platform a small percentage of these savings rather than paying the credit card association its standard fees.

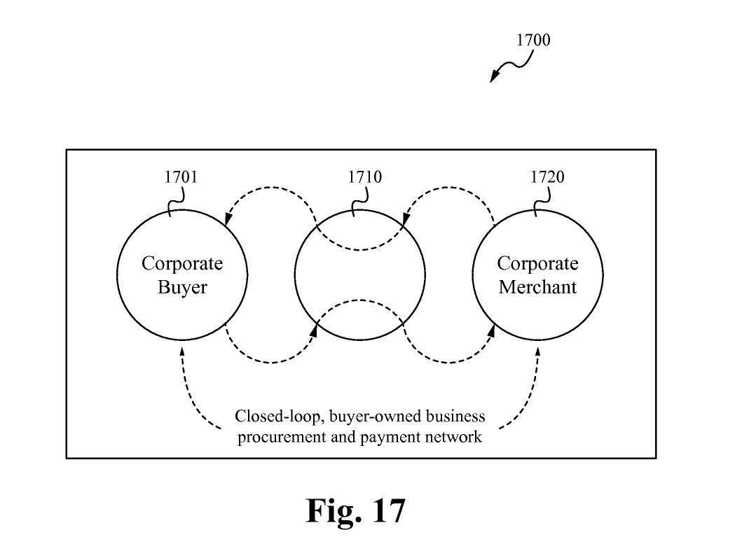

FIG. 17 shows a closed-loop business payment network 1700 in accordance with one embodiment of the invention. The network 1700 includes a buyer system 1701 and a merchant system 1720 coupled over a closed-loop network 1710 in which the buyer 1701 is both the issuer and the acquirer of payment credentials to offer payment services. The closed-loop platform does not rely on banks or other financial institutions. In this embodiment, the buyer 1701 uses its card (or account number) to purchase an item from the merchant 1720. The merchant 1720 connects to the buyer 1701 to request authorization for the transaction. The buyer 1701 responds with an authorization number. The merchant 1720 submits an invoice to the network 1720, which processes the invoice and executes payment directly to the merchant 1720. The network 1710, which includes a processing platform, is hosted by the buyer or a third-party.

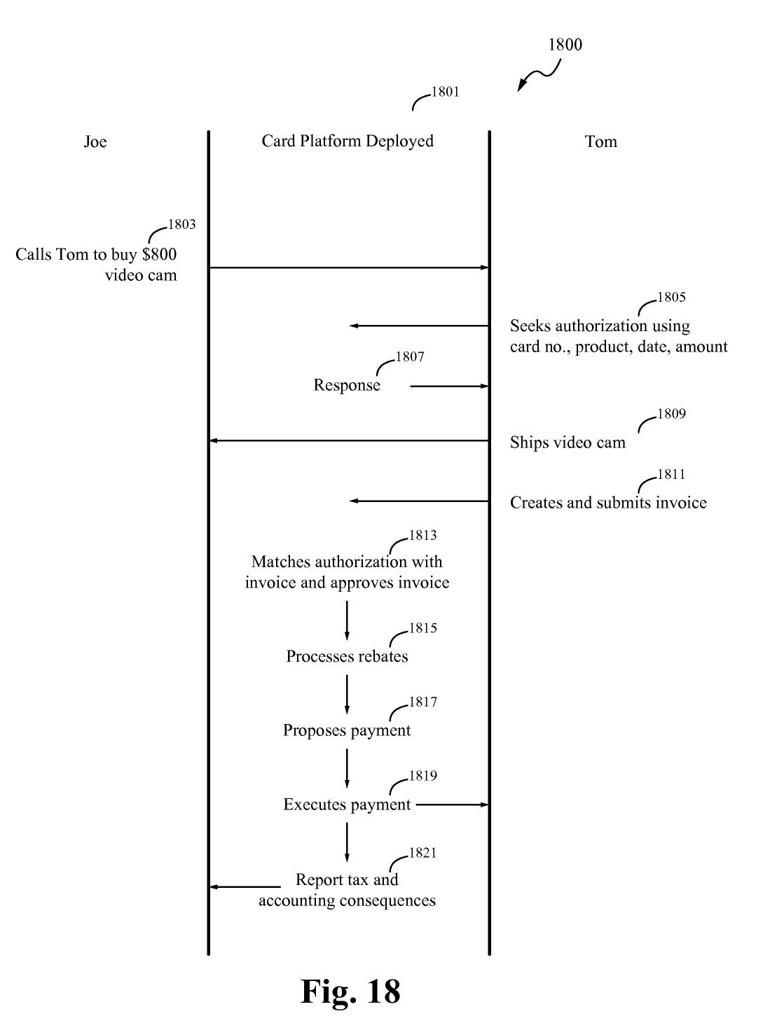

FIG. 18 shows a process flow 1800 for an “offline” closed-loop credit card transaction between a buyer with a company ABC and a supplier XYZ in accordance with one embodiment of the invention. Initially, the closed-loop platform is deployed (1801) with ABC and XYZ, though other companies can also join. Joe, an employee of ABC, is issued a card for purchases using the platform, having a card number 4285-6813-2017-6251-030. Sections of the card identify, among other things, the type of card (analogous to a credit card within the closed-loop system), the company that is the issuer and the borrower (e.g., ABC), and the account number for the particular employee (e.g., Joe).

Joe calls Tom, an employee of XYZ, to purchase an $800 video cam (1803). Tom sends to the platform an authorization request using a mobile, Web browser, or some other application (1805). Tom includes in the authorization request Tom's identifier, Joe's card number, the product being purchased (a video cam), the date, and an amount of the purchase. The platform generates a response, either an authorization number or a decline, and sends it to Tom (1807). If Tom received an authorization number, he ships the video cam to Joe (1809), generates an invoice, and submits the invoice to the platform (1811). The platform then matches the authorization with the invoice (1813), processes any rebates (1815), such as described above, proposes payment (1817), and executes the payment (1819), which may include sending payment directly to Tom from an ABC account on the platform or instructing a third party financial institution (e.g., bank) to send payment to XYZ. The platform then reports tax and accounting consequences to ABC (1821).

Preferably, the steps 1807, 1813, 1815, 1817, 1819, and 1821 are performed automatically on the platform. In one embodiment, the platform includes a memory containing computer-executable instructions for performing the steps 1807, 1813, 1815, 1817, 1819, and 1821, and one or more processors for executing these instructions.

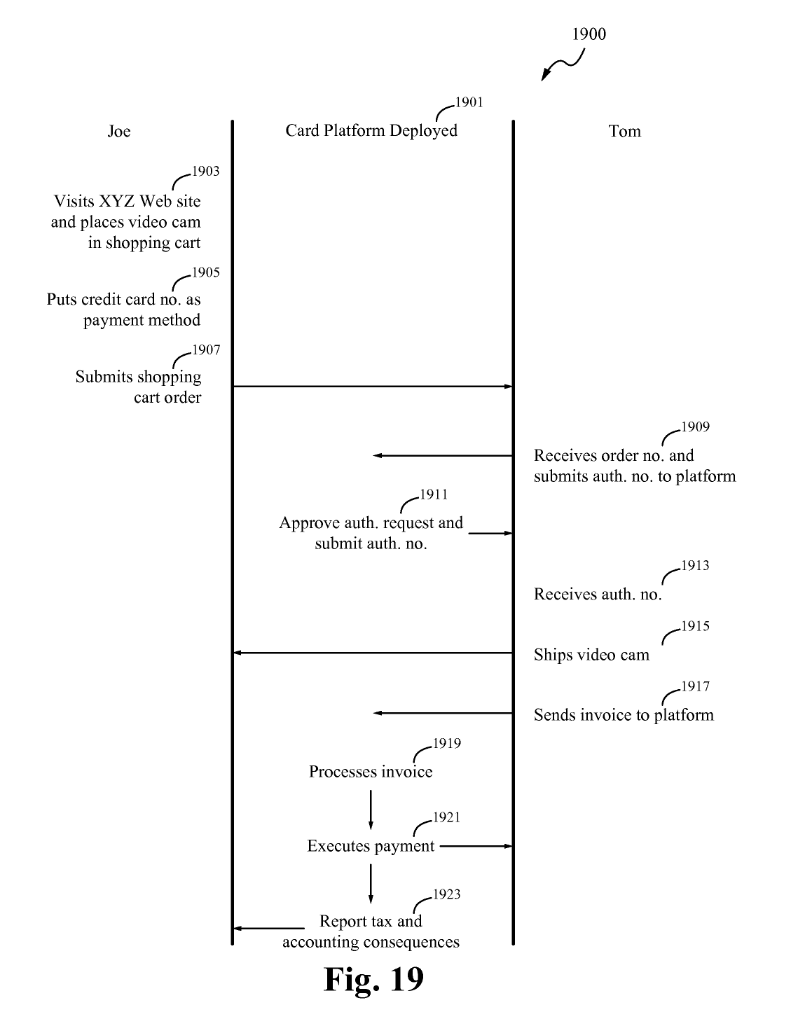

FIG. 19 shows a process flow for a closed-loop credit-card transaction in accordance with the invention, when the buyer is connected to the Web. As in the flow 1800, initially the card platform is deployed (1901) and Joe is issued a company card. Joe visits XYZ's Web site, sees a video cam in the online catalog, and places it in the online shopping cart (1903). Joe enters his card number as the payment method (1905) and submits the shopping cart order (1907). XYZ's system receives the order with the order number and submits an authorization request to the card platform (1909). If the authorization is approved, the platform submits an authorization number to XYZ (1911), which receives it (1913) and ships the video cam to Joe (1915). XYZ sends the invoice to the platform (1917), which processes the invoice (1919), pays XYZ (1921), and reports any tax and accounting consequences to ABC (1923).

Preferably, the steps 1911, 1919, 1921, and 1923 are performed automatically on the platform. In one embodiment, the platform includes a memory containing computer-executable instructions for performing the steps 1911, 1919, 1921, and 1923 and one or more processors for executing these instructions.

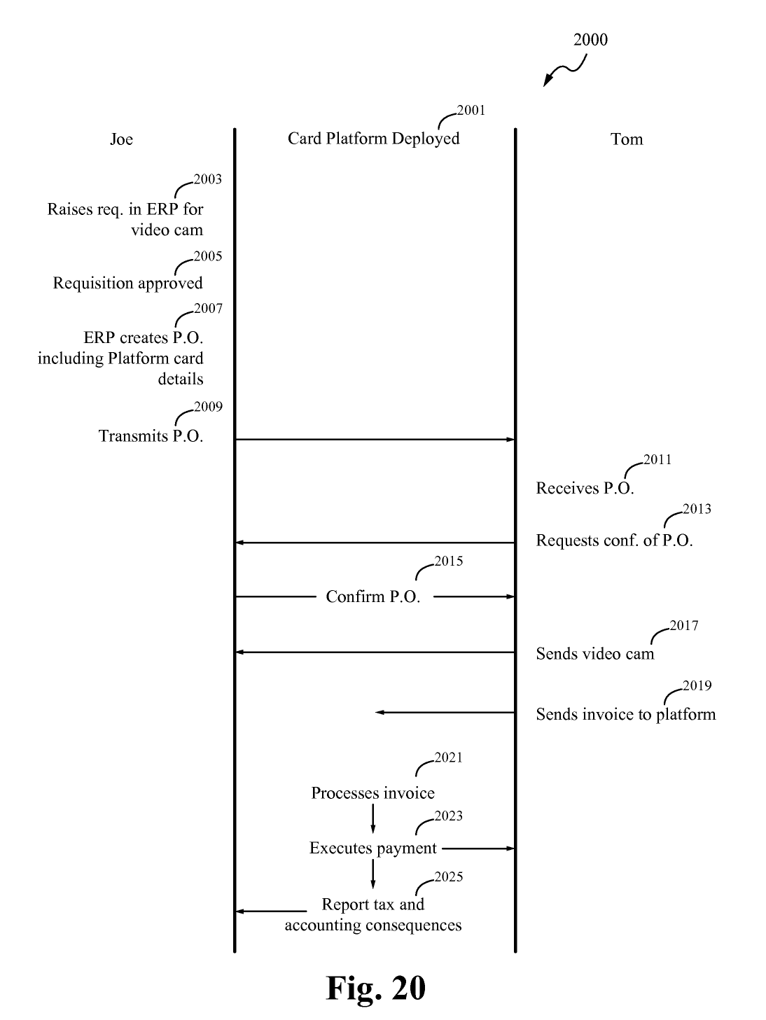

FIG. 20 shows a process flow 2000 for a closed-loop card transaction in accordance with the invention, when the transaction originates in ABC's Enterprise Resource Planning (ERP) program. In this example, ABC uses ERP for its procurements. Again, the card platform is deployed (2001). Joe has an ABC closed-loop card and the ERP allows recording of a lodge card, that is, a card that is used or “lodged” with a single supplier, can be used only on specific terminals, such as a point of sale, or can be used for only specific items, such as hotels, airline tickets, and the like.

Referring to FIG. 20, Joe wishes to purchase a video camera from XYZ and raises a requisition in ERP (501) to do so (2003). The requisition is approved (2005), and the ERP creates a purchase order (PO) that includes details of the product (e.g., product number, quantity) and Joe's ABC credit-card number (2007). The PO is sent to XYZ (2009), who receives it (2011). XYZ contacts the platform to confirm the PO (2013) and receives confirmation (2015). When XYZ receives the confirmation, it ships the video cam to Joe (2017) and sends an invoice to the platform (2019). The platform then processes the invoice (2021), including applying any variable early-payment rebates, applying any other services (e.g., insurance and foreign exchange), pays XYZ (2023), and sends tax and accounting information to ABC (2025). The processing can also include additional services such as purchase authorizations and proactive notifications of change of circumstances.

Preferably, the steps 2015, 2021, 2023, and 2025 are performed automatically on the platform. In one embodiment, the platform includes a memory containing computer-executable instructions for performing the steps 2015, 2021, 2023, and 2025 and one or more processors for executing these instructions.

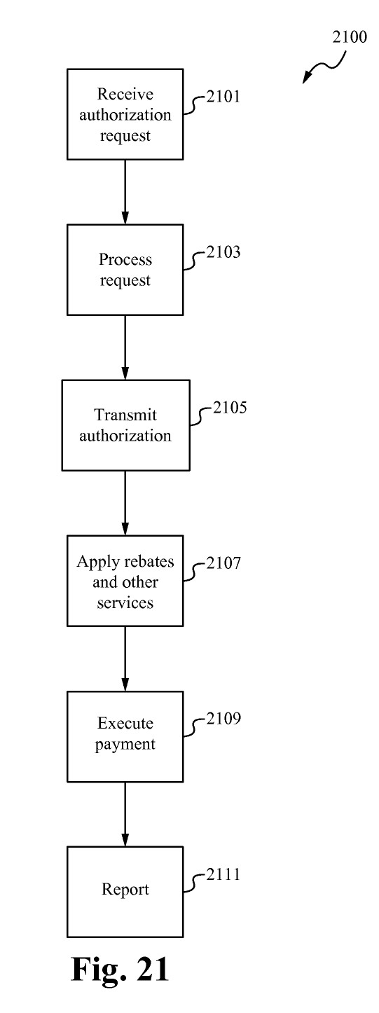

FIG. 21 is a high-level flow chart of the steps 2100 of a method of processing a closed-loop credit card transaction in accordance with one embodiment of the invention. In the step 2101, an authorization request is received, including a user's credit card. In the step 2103, the request is processed, such as by matching an invoice to an authorization number, ensuring that purchase restrictions are satisfied and sufficient funds are in the user's account. An authorization is transmitted in the step 2105. Any rebates and other services are applied in the step 2107. Payment is made in the step 2109, and reports are generated in the step 2111.

Preferably, the steps 2101, 2103, 2105, 2107, 2109, and 2111 are performed automatically on the platform. In one embodiment, the platform includes a memory containing computer-executable instructions for performing the steps 2101, 2103, 2105, 2107, 2109, and 2111 and one or more processors for executing these instructions.

Rebate programs are also described in, “Systems for and Methods of Capturing and Analyzing Benefits in Commercial Transactions,” Attorney Docket No. OXYG-00101, by David Brown, Mark Taylor, and Mike Murphy, filed herewith; “Systems for and Methods of Securitizing Asset-Backed Supplier Rebate Cash Flows Derived from Procurement Expenditures,” Attorney Docket No. OXYG-00201, by David Brown, Keith Ballantine, Mike Murphy, and Keith Cotterill, filed herewith; and “Systems for and Methods of Establishing Closed-Loop Business Payment Services,” Attorney Docket No. OXYG-00300, by David Brown, Mark Taylor, Mike Murphy, and Keith Ballantine, filed herewith, all of which are incorporated by reference in their entireties.

In operation, a buyer negotiates purchase agreements with one or more merchants. An agreement contains, among other things, a variable early-payment rebate schedule and a minimum purchase requirement. The buyer is able to have different rebate schedules, minimum purchase requirements, and other arrangements with each merchant. A rebate processing system is configured for processing transactions under these agreements. The system is initialized with any purchase restrictions imposed on the buyer, additional services purchased by the buyer, such as insurance or foreign exchange-rate adjustments. When the buyer attempts to purchase an item, the purchasing restrictions are used to determine whether the transaction is authorized. If the transaction is authorized, the system calculates the rebate and applies it and any other services to the transaction on a per-transaction basis. The services can be bundled in many ways configurable by the buyer. When payments are made, they are “augmented” by selected services so that multiple services can be applied. The system processes the payment, by directly sending payment to the seller or authorizing payment by a third party. When the services are performed, appropriate updates take place in the corporation's systems to reflect the new situation. Because the system has access to service contracts and the like, it is able to generate detailed reports about savings from rebates and these services, and can organize these reports in any way suitable for the analysis at hand.

The system integrates with a corporation's existing systems. The system is hosted on a buyer's corporate system but can be hosted by a third-party.

In one embodiment, the variable early-payment rebate program is implemented in a closed-loop payment network, in which a buyer (e.g., company) is both an issuer and an acquirer.

It will be appreciated that while the examples describe a system for processing transactions between a single buyer and a single seller, the system can be extended to process transactions between a single buyer and multiple sellers or any combinations of buyers and sellers.

The embodiments given above are shown merely for illustration and are not meant to limit the scope of the invention. It will be readily apparent to one skilled in the art that other modifications may be made to the embodiments without departing from the spirit and scope of the invention as defined by the appended claims.

We claim:

1. A method of applying services to an individual transaction between a buyer and a seller comprising:
determining, on a computer system, services based on aggregate prospective transactions between a buyer and a supplier, wherein the services include a variable early-payment rebate service; and
applying, on the computer system, the services individually to each transaction between the buyer and the supplier, wherein the services are purchased in aggregate.

2. The method of claim 1, wherein the services comprise a volume-based rebate service.

3. The method of claim 1, wherein the services comprise a foreign-exchange service, an insurance service, a commodities service, or any combination thereof.

4. The method of claim 1, wherein the services are selected by the buyer.

5. The method of claim 1, wherein the services are provided by a third party.

6. The method of claim 1, wherein the variable early-payment rebate varies inversely with a number of days into an invoice payment cycle the buyer settles its account with the seller.

7. The method of claim 1, further comprising reporting statistics relating to the early-payment rebates, relating to the services, or relating to both the early-payment rebates and services.

8. The method of claim 7, wherein the statistics include a summary of insurance coverage or foreign exchange rate savings over a period selected by the buyer.

9. The method of claim 7, wherein the statistics include a summary of rebates over a period organized by invoice, product category, or any combination thereof.

10. A system for applying one or more services to transactions between a buyer and a supplier comprising:
a database for storing invoices corresponding to transactions between the buyer and the supplier;
one or more services based on prospective aggregate transactions between the buyer and the supplier; and
a financial transaction services engine configured to apply selected ones of the one or more services individually to each transaction between the buyer and the supplier.

11. The system of claim 10, further comprising a configuration file correlating each of the invoices with selected ones of the one or more services.

12. The system of claim 10, wherein the one or more services comprise a variable early-rebate service and a volume-based rebate service.

13. The system of claim 12, wherein the variable early-rebate service is based on a number of days an actual payment-in-full date precedes a payment-in-full due date.

14. The system of claim 13, wherein the one or more services further comprise an insurance service, a foreign-exchange service, or both.

15. The system of claim 14, wherein the foreign-exchange service determines a foreign currency favorable to the buyer in settling the transaction and processes the transaction in the foreign currency.

16. The system of claim 15, wherein processing the transaction comprises paying the supplier directly in the foreign currency.

17. The system of claim 15, wherein processing the transaction comprises instructing a third party to settle the transaction in the foreign currency.

18. The system of claim 17, wherein the third party is a financial institution.

19. The system of claim 10, wherein at least one of the one or more services is a third-party service.

20. The system of claim 10, wherein the system is configured to update a buyer-accessible database to reflect the one or more services.

21. The system of claim 10, further comprising a report generator configured to generate one or more reports relating to the rebates, to the one or more services, or to both the rebates and the one or more services.

22. The system of claim 21, wherein the one or more reports include a summary of savings by foreign-exchange.
